(19) United States
(12) Patent Application Publication
(10) Pub. No.: US 2008/0130561 A1
(43) Pub. Date: Jun. 5, 2008

(54) SYSTEM AND METHOD FOR WIRELESS COMMUNICATION

(75) Inventors: Huai-Rong Shao, San Jose, CA (US); Harkirat Singh, Santa Clara, CA (US); Chiu Ngo, San Francisco, CA (US)

Correspondence Address: KNOBBE, MARTENS, OLSON, & BEAR, LLP, 2040 MAIN STREET, FOURTEENTH FLOOR, IRVINE, CA, 92614, US

(73) Assignee: Samsung Electronics Co., Ltd., Suwon City (KR)

(21) Appl. No.: 11/864,846

(22) Filed: Sep. 28, 2007

Related U.S. Application Data
(60) Provisional application No. 60/872,838, filed on Dec. 4, 2006.

(51) Int. Cl. H04Q 7/00

(52) U.S. Cl. 370/329

(57) ABSTRACT

A system and method for wireless communication is disclosed. In one aspect, the method comprises generating a physical (PHY) frame comprising a PRY layer header and a PHY payload data packet, wherein the PHY layer header comprises an aggregation indication bit for indicating whether the PHY payload data packet comprises two or more sub-packets received from the application layer. The method further comprises transmitting the PHY frame.

### CROSS REFERENCE TO RELATED APPLICATIONS

This application claims priority under 35 U.S.C. §119(e) to U.S. Provisional Patent Application No. 60/872,838 filed on Dec. 4, 2006, which application is hereby incorporated by reference in its entirety.

### BACKGROUND OF THE INVENTION

1. Field of the Development

The disclosure relates to wireless communication, and in particular, to transmission of uncompressed high definition video information over wireless channels.

2. Description of the Related Technology

With the proliferation of high quality video, an increasing number of electronic devices, such as consumer electronic devices, utilize high definition (HD) video which can require multiple gigabits per second (Gbps) in bandwidth for transmission. As such, when transmitting such HD video between devices, conventional transmission approaches compress the HD video to a fraction of its size to lower the required transmission bandwidth. The compressed video is then decompressed for consumption. However, with each compression and subsequent decompression of the video data, some data can be lost and the picture quality can be reduced.

The High-Definition Multimedia Interface (HDMI) specification allows transfer of uncompressed HD signals between devices via a cable. While consumer electronics makers are beginning to offer HDMI-compatible equipment, there is not yet a suitable wireless (e.g., radio frequency) technology that is capable of transmitting uncompressed HD video signals. Wireless local area network (WLAN) and similar technologies can suffer interference issues when several devices are connected which do not have the bandwidth to carry the uncompressed HD signals.

### SUMMARY OF CERTAIN INVENTIVE ASPECTS

The system, method, and devices of the invention each have several aspects, no single one of which is solely responsible for its desirable attributes. Without limiting the scope of this invention, its more prominent features will now be briefly discussed.

In one aspect, a method of transmitting data in a wireless network is disclosed. The method comprises generating a physical (PHY) frame comprising a PHY layer header and a PHY payload data packet, wherein the PHY layer header comprises an aggregation indication bit for indicating whether the PHY payload data packet comprises two or more sub-packets received from the application layer. The method further comprises transmitting the PHY frame.

In another aspect, a system for transmitting data in a wireless network is disclosed. The system comprises means for generating a physical (PHY) layer frame comprising a PHY header and a PHY payload, the PHY payload comprising one or more packets from the application layer, wherein the PHY header comprises an aggregation indication bit for indicating whether the PHY payload comprises two or more packets from the application layer. The system further comprises means for transmitting the PHY frame.

In another aspect, a system for transferring data in a wireless network is disclosed. The system comprises a transmitter configured to 1) generate a physical (PHY) frame comprising a PHY header and a PHY payload, the PHY payload comprising one or more packets from the application layer, wherein the PHY header comprises an aggregation indication bit for indicating whether the PHY payload comprises two or more packets from the application layer, and 2) transmit the PHY frame. The system further comprises a receiver configured to receive a PHY frame from the transmitter, determine whether the frame is aggregated based on the aggregation indication field, and process the PHY frame based on whether the frame is aggregated.

### BRIEF DESCRIPTION OF THE DRAWINGS

FIG. 1 shows a functional block diagram of a wireless network 100 that implements uncompressed HD video transmission.

FIG. 2 illustrates a functional block diagram of an example communication system 200.

FIG. 3 is a diagram illustrating the high-rate channel and low-rate channel between a station and a coordinator.

FIG. 4A is a diagram illustrating one embodiment of a LRP header for use in an LRP frame.

FIG. 4B is a diagram illustrating another embodiment of a LRP header for use in an LRP frame.

FIG. 5 is a diagram illustrating one embodiment of an LRP frame format for beamformed mode.

FIG. 6 is a diagram illustrating the MAC header in FIG. 4.

FIG. 7 is a diagram illustrating a MAC control field in FIG. 6.

FIG. 8 is a diagram illustrating another embodiment of a LRP frame format for beamformed mode.

FIG. 9 is a diagram illustrating another embodiment of a LRP frame format for beamformed mode.

FIG. 10 is a diagram illustrating a LRP header for use in LRP frame.

FIG. 11 is a diagram illustrating one embodiment of a LRP frame format for omni-directional mode.

FIG. 12 is a diagram illustrating another embodiment of a LRP frame format for omni-directional mode.

FIG. 13 is a diagram illustrating another embodiment of a LRP frame format for omni-directional mode.

FIG. 14 is a flowchart illustrating one embodiment of a method of transferring data in a wireless communication network for uncompressed video.

### DETAILED DESCRIPTION OF CERTAIN EMBODIMENTS

The following detailed description of certain embodiments presents various descriptions of specific embodiments of the invention. However, the invention can be embodied in a multitude of different ways as defined and covered by the claims. In this description, reference is made to the drawings wherein like parts are designated with like numerals throughout.

The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

### Overview of a Wireless Network

Some embodiments of a wireless network which supports transmission of uncompressed high definition video will now be described.

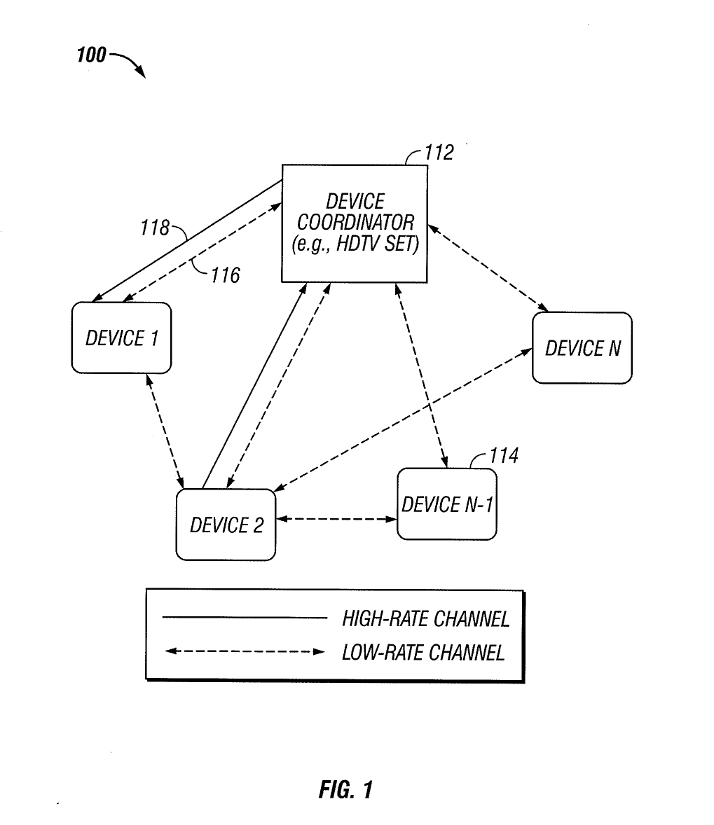

FIG. 1 shows a functional block diagram of a wireless network 100 that implements uncompressed HD video transmission between A/V devices such as an A/V device coordinator and A/V stations, according to certain embodiments. In other embodiments, one or more of the devices can be a computer, such as a personal computer (PC). The network 100 includes a device coordinator 112 and multiple A/V stations 114 (e.g., Device 1, . . . , Device N). In one embodiment, the wireless network 100 is a high data rate 60 GHz millimeter wave wireless network.

The A/V stations 114 utilize a low-rate (LR) wireless channel 116 (dashed lines in FIG. 1), and may use a high-rate (HR) channel 118 (heavy solid lines in FIG. 1), for communication between any of the devices. The device coordinator 112 uses a low-rate channel 116 and a high-rate wireless channel 118 for communication with the stations 114. Each station 114 uses the low-rate channel 116 for communications with other stations 114. The high-rate channel 118 supports single direction unicast transmission over directional beams established by beamforming, with e.g., multi-Gb/s bandwidth, to support uncompressed HD video transmission. For example, a set-top box can transmit uncompressed video to a HD television (HDTV) over the high-rate channel 118. The low-rate channel 116 can support bi-directional transmission, e.g., with up to 40 Mbps throughput in certain embodiments. The low-rate channel 116 is mainly used to transmit control frames such as acknowledgement (ACK) frames. For example, the low-rate channel 116 can transmit an acknowledgement from the HDTV to the set-top box. It is also possible that some low-rate data like audio and compressed video can be transmitted on the low-rate channel between two devices directly. In certain embodiments, time division duplexing (TDD) is applied to the high-rate and low-rate channel. At any one time, the low-rate and high-rate channels cannot be used in parallel for transmission. Beamforming technology can be used in both low-rate and high-rate channels. The low-rate channels can also support omni-directional transmissions, in addition to beamformed transmission.

As described above, the network 100 includes two types of devices, coordinator and station. The coordinator controls the timing in the network, keeps track of the members of the network, and transmits or receives data using either the low-rate or high-rate channel. The station transmits and receives data using the low-rate channel, initiates stream connections, and transmits or receives data using the high-rate channel. The station may be capable of acting as a coordinator in the network. Such a station is referred to as being coordinator capable.

In one example, the device coordinator 112 is a receiver of video information (hereinafter “receiver 112”), and the station 114 is a transmitter of the video information (hereinafter “transmitter 114”). For example, the receiver 112 can be a sink of video and/or audio data implemented, such as, in an HDTV set in a home wireless network environment which is a type of WLAN. The transmitter 114 can be a source of uncompressed video or audio. Examples of the transmitter 114 include a set-top box, a DVD player or recorder, a digital camera, a camcorder, and so forth. A station 114 can also be a sink of video and/or audio data.

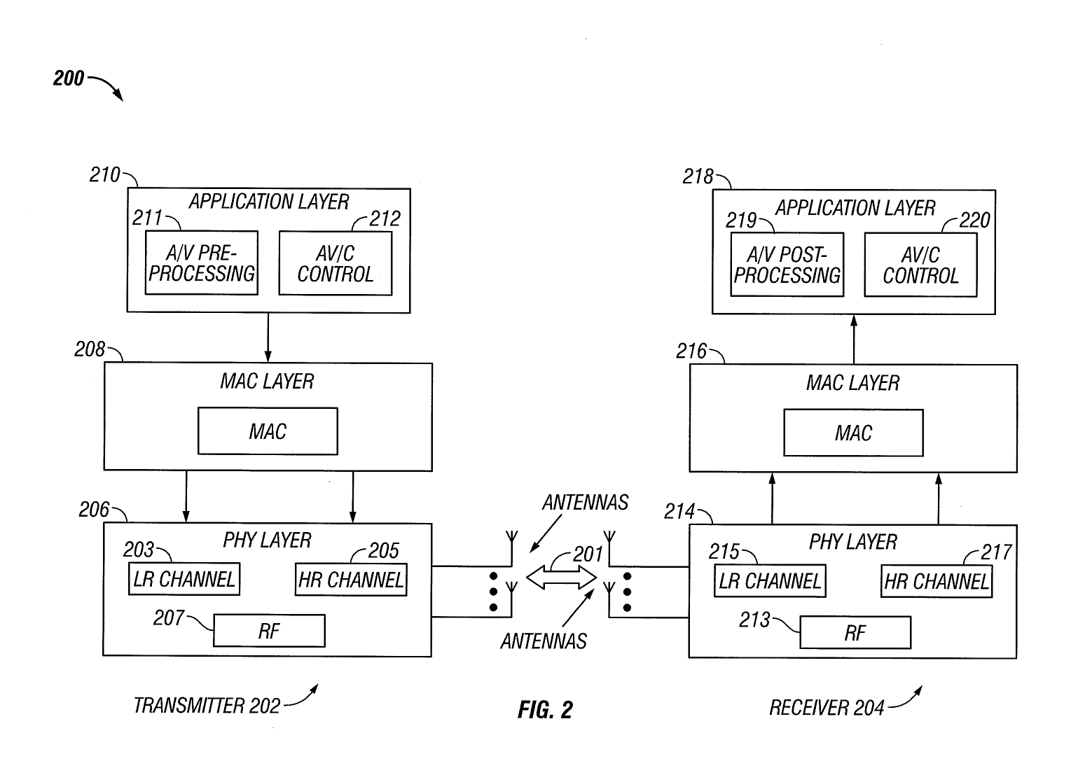

FIG. 2 illustrates a functional block diagram of an example communication system 200. The system 200 includes a wireless transmitter 202 and a wireless receiver 204. The transmitter 202 includes a physical (PHY) layer 206, a media access control (MAC) layer 208 and an application layer 210. Similarly, the receiver 204 includes a PHY layer 214, a MAC layer 216, and an application layer 218. The PHY layers provide wireless communication between the transmitter 202 and the receiver 204 via one or more antennas through a wireless medium 201.

The application layer 210 of the transmitter 202 includes an A/V pre-processing module 211 and an audio video control (AV/C) module 212. The A/V pre-processing module 211 can perform pre-processing of the audio/video such as partitioning of uncompressed video. The AV/C module 212 provides a standard way to exchange A/V capability information. Before a connection begins, the AV/C module negotiates the A/V formats to be used, and when the need for the connection is ended, AV/C commands are used to stop the connection.

In the transmitter 202, the PHY layer 206 includes a low-rate (LR) channel 203 and a high rate (HR) channel 205 that are used to communicate with the MAC layer 208 and with a radio frequency (RF) module 207. In certain embodiments, the MAC layer 208 can include a packetization module (not shown). The PHY/MAC layers of the transmitter 202 add PHY and MAC headers to packets and transmit the packets to the receiver 204 over the wireless channel 201.

In the wireless receiver 204, the PHY/MAC layers 214, 216 process the received packets. The PHY layer 214 includes a RF module 213 connected to the one or more antennas. A LR channel 215 and a HR channel 217 are used to communicate with the MAC layer 216 and with the RF module 213. The application layer 218 of the receiver 204 includes an AN post-processing module 219 and an AV/C module 220. The module 219 can perform an inverse of the processing method of the module 211 to regenerate the uncompressed video, for example. The AV/C module 220 operates in a complementary way with the AV/C module 212 of the transmitter 202.

The high-rate PHY (HRP) 205 is a PHY that supports multi-Gb/s throughput at distance of 10 m through adaptive antenna technology. In one embodiment, the HRP 205 is the high-rate channel shown in FIG. 1 above. The HRP is highly directional and can only be used for unicast connections as shown above in FIG. 1. The HRP is optimized for the delivery of uncompressed high-definition video, and other data can be communicated using the HRP. To support multiple video resolutions, the HRP has more than one data rate defined. The HRP carries isochronous data such as audio and video, asynchronous data, MAC commands, antenna steering information, and higher layer control data for A/V devices.

The low-rate PHY (LRP) 203 is a multi-Mb/s bidirectional link that also provides a range of 10 m. In one embodiment, the LRP 203 is the low-rate channel shown in FIG. 1 above. Multiple data rates are defined for the LRP, with the lower data rates having near omni-directional coverage while the highest data rates are directional. Because the LRP has near omni-directional modes, it can be used for both unicast and broadcast connections. Furthermore, because all stations support the LRP, it can be used for station-to-station links. The LRP supports multiple data rates, including directional modes, and is used to carry low-rate isochronous data such as audio, low-rate asynchronous data, MAC commands including the beacon frame, acknowledgements for HRP packets, antenna steering information, capabilities information, and higher layer control data for A/V devices.

The HRP and LRP operate in overlapping frequency bands and so they are coordinated in a TDMA (time division multiple access) manner by the MAC. The WVAN supports at least one uncompressed 1080p video stream with associated audio at a time. Multiple lower rate uncompressed video streams, e.g., two 1080i video streams, are also supported.

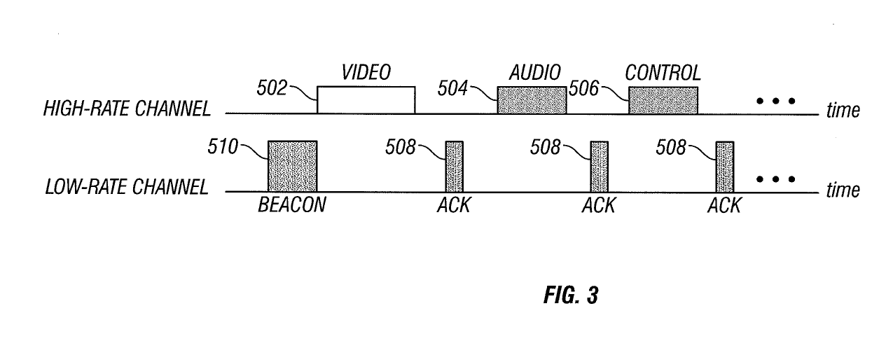

FIG. 3 is a diagram illustrating further the high-rate channel and low-rate channel between a station and a coordinator. As illustrated, the high-rate channel can transmit, for example, a video packet 502, an audio packet 504, or a control packet 506. The low-rate channel can transmit a beacon signal 510, or an acknowledgment packet 508. As illustrated, at any time, the low-rate and high-rate channel cannot be used in parallel for transmission.

For the same amount of information, the transmission duration over the high-rate channel is much shorter than over the low-rate channel. After a packet is transmitted from the device 1 to device 2 on the high-rate channel, an ACK packet is sent from device 2 to device 1 on the low-rate channel to acknowledge receipt of the packet. A certain amount of time is required for the switching between high-rate and low-rate channels. Therefore, frequent channel switching could degrade the network throughput since no data can be transmitted during channel switching time.

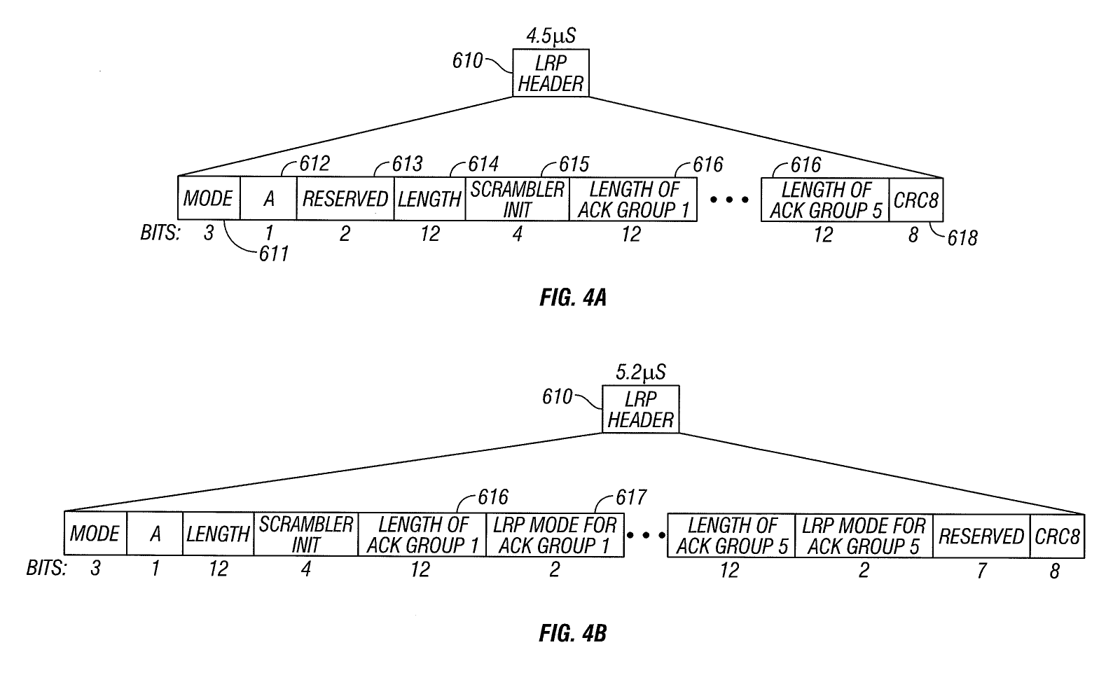

Certain embodiments of a LRP frame format will be described below with regard to FIGS. 4-14. One inventive aspect of these embodiments is to provide an option to aggregate a couple of sub-packets from the application layer in one LRP frame. Since several sub-packets may be transmitted with one LRP header, the overhead incurred for each sub-packed transmitted is reduced. This improves the transmission efficiency. As described above, the low-rate channel can operate in two different modes of transmission: omni-directional mode and beamformed mode. Accordingly, two types of LRP frame format, one for each mode are defined below for supporting data transfer.

### LRP Frame Format for Beamformed Mode

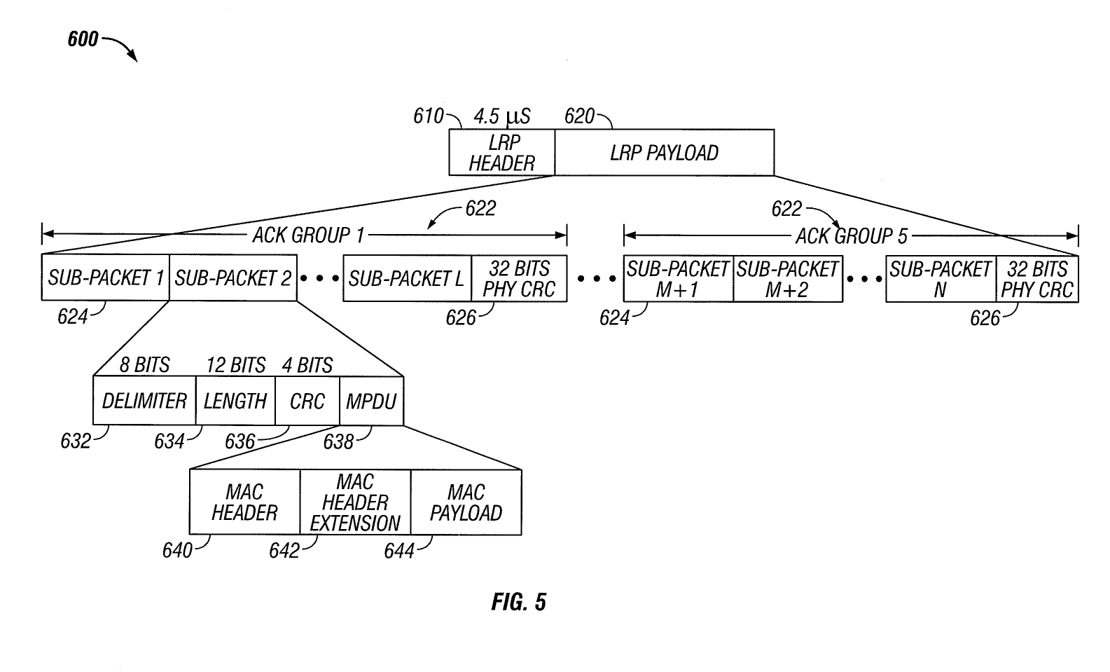

FIG. 5 is a diagram illustrating a LRP frame format 600 for beamformed mode, and FIGS. 4A and 4B are diagrams illustrating a LRP header 610 for use with the header part shown in FIG. 5.

Referring to FIG. 4A, in the LRP header 610, one aggregation indication bit 612 is used to indicate whether the associated frame is an aggregated frame or not. The aggregation indication bit is denoted as “A”. For beamformed mode, the “A” bit 612 is typically set to “1”, and the LRP frame format is as illustrated in FIG. 5. However, the “A” bit 612 can also be set to “0”, in which case the LRP frame format will be as illustrated below in FIG. 8. The LRP header also includes ACK group length information of 12 bits in 616 to indicate the length of each ACK group. In the illustrated embodiment, there are a total of 5 ACK groups in the LRP frame since in the illustrated example, a short ACK message used by a receiver to acknowledge a LRP frame has 5 ACK bits. Each ACK bit is used to indicate whether a corresponding ACK group in the LRP frame is correct when being received.

In one embodiment, the entire 60 bits (including length information for the five ACK groups) is coded into 4 symbols with rate-½ tail biting FEC. Lastly, the LRP header 610 may further comprise fields for mode 611, reserved 613, length 614, scrambler initial 615, and cyclic redundancy checksum (CRC) 618.

In FIG. 4A, the same LRP mode is used for all ACK groups. It is also possible to use different LRP modes for different ACK group payloads as shown in FIG. 4B. In FIG. 4B, a two bit LRP mode 617 for each ACK group is added to indicate the modulation and coding mode used by the ACK group.

Referring to FIG. 5, in the LRP payload 620, there can be multiple sub-packets 624. Each sub-packet 624 begins with an 8-bit delimiter 632, a 12-bit length information 634, a 4-bit CRC 636, and a MAC protocol data unit (MPDU) 638. The MPDU 638 comprises a MAC header 640, a MAC header extension 642 if there is security or link adaptation header information, and a MAC payload information, e.g., MAC service data unit (MSDU) 644. The Delimiter 632 may be set to a specific pattern, for example, ASCII code N.

These sub-packets 624 are grouped into five ACK groups 622. Each ACK group 622 can have one or multiple sub-packets 624. Each ACK group 622 is also appended by a 4-byte CRC 626. The size of each ACK group 622 can be fixed if the PHY design has such a limitation. In this case, null data may need to be appended to the end of an ACK group 622 if sub-packets 624 from the upper layer have variable sizes.

As described above, the packet 600 includes a CRC 622 for each ACK group and a CRC 636 for each sub-packet. This scheme offers certain benefits as discussed below.

A cyclic redundancy checksum (CRC) is a value which is computed from a block of data, such as a packet of data communicated via network communication. The checksum is used to detect errors after transmission. A CRC is computed and appended to the packet of data before transmission, and verified afterwards by the recipient to confirm that no changes occurred during the transmission.

Upon receiving the LRP frame 600, the receiver checks the ACK group CRC 626 to determine whether some bits in the associated ACK group 622 are wrong. If the ACK group CRC 626 indicates that bits in the associated ACK group 622 are correct at the receiver, the CRC 636 for each sub-packet within the ACK group 622 does not have to be checked. In one scheme, the PHY layer at the receiver sets one ACK bit, which corresponds to the ACK group 622 in the received frame, in a short ACK packet to indicate whether bits of the ACK group 622 are correct. Because the PHY layer at the receiver does not necessarily need to analyze each sub-packet before the PHY layer sends the short ACK packet, the inter-frame time delay between a frame and the short ACK can be reduced.

When the sender receives a short ACK packet indicating that some bits in an ACK group 622 are wrong, the sender may re-send all sub-packets 624 in the ACK group 622.

In one embodiment, the PHY layer moves all sub-packets 624 in an ACK group 622 to the MAC layer even ACK group CRC 626 reports errors for the ACK group 622. The MAC layer of the receiver side may know which sub-packets are correct based on the CRC check 636 for each sub-packet. From multiple sub-packets 624 within one ACK group 622, the MAC layer can pick those sub-packets 624 whose own CRCs 636 are correct. In some applications such as video or audio applications, the MAC layer of the receiver side may send a sub-packet 624 to an upper layer (e.g., an application layer) even if the CRC 636 for the sub-packet is wrong, since the upper layer may be able to use the payload information within the incorrect sub-packet 624.

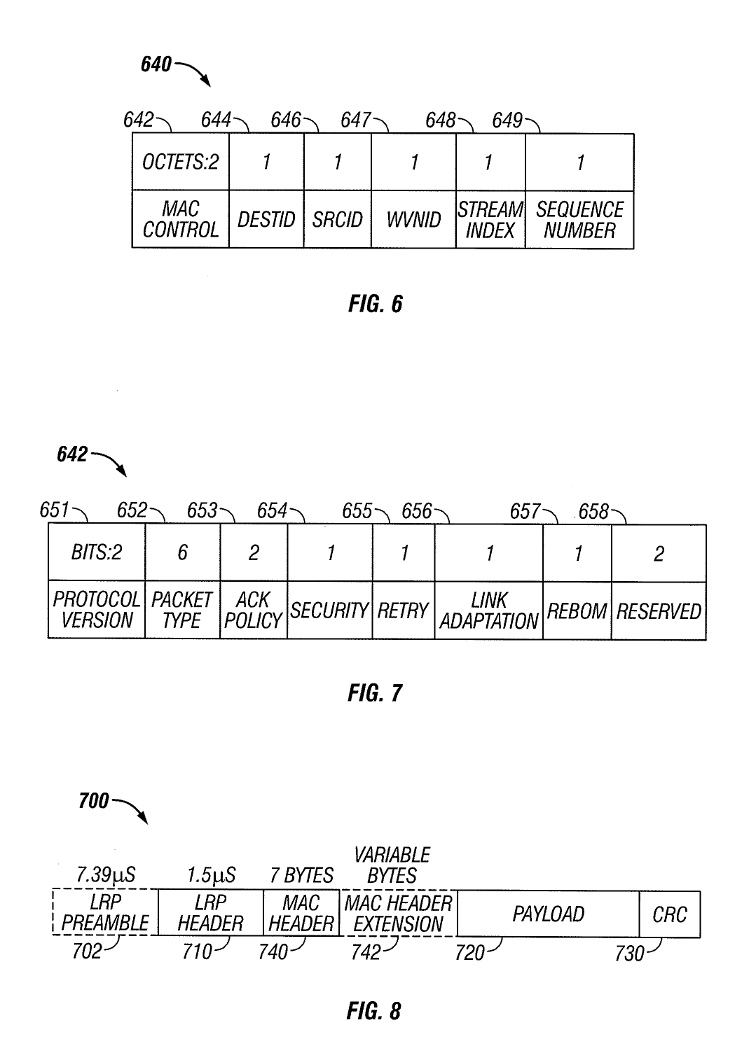

FIGS. 6 through 7 provide more detail regarding the MAC header 640 shown in FIG. 5. More particularly, FIG. 6 is a diagram illustrating a MAC header according to an embodiment of the invention; FIG. 7 is a diagram illustrating a MAC control field in FIG. 6.

The MAC header 640 comprises fields for MAC control 642, destination ID 644, source ID 646, wireless video area network ID (WVNID) 647, stream index 648, and sequence number 649. Referring to FIG. 7, the MAC control field 642 comprises sub-fields for protocol version 651, packet type 652, ACK policy 653, security 654, retry 655, link adaptation 656, ReBom 657 and reserved space 658.

The security 654, when set to “1”, indicates whether there is security or link adaptation header information stored in the MAC header extension part after the MAC header. For beamformed transmission, since no ReBoM is supported, ReBoM bit 657 can be set to “0”, or this bit can be removed from the MAC control field.

Each sub-packet 624 has its own MAC header 640 configured in the frame format discussed with regard to FIG. 5. This scheme allows sub-packets with different settings in the MAC control field to be aggregated together. For example, different kinds of packets such as beacon, data, and MAC control frames can be aggregated together. Also, re-transmitted packets and originally retransmitted packets can be aggregated. In addition, this scheme improves data transmission reliability. Errors in one MAC header will not affect other sub-packets.

FIG. 8 is a diagram illustrating an exemplary format of the non-aggregated LRP frame format for beamformed mode. The LRP frame 700 comprises fields for LRP preamble 702, LRP header 710, MAC header 740, MAC header extension 742, payload 720, and CRC 730.

Unlike the LRP header 610 shown in FIGS. 4A and 4B, the LRP header 710 has the “A” bit set to “0”, indicating that no aggregation of the sub-packets is to be conducted. There are no sub-packets in the payload 720. The MAC layer treats the whole payload as one unit for the non-aggregated LRP frame format. Unlike the LRP frame format in FIGS. 4A and 6B wherein each sub-packet has its own MAC header and MAC header extension, the frame format in FIG. 8 has a single MAC header 740, MAC header extension 742, and CRC 730 for the whole payload 720. This scheme reduces the header overhead since there is a single a single MAC header, MAC header extension and CRC for the entire LRP frame.

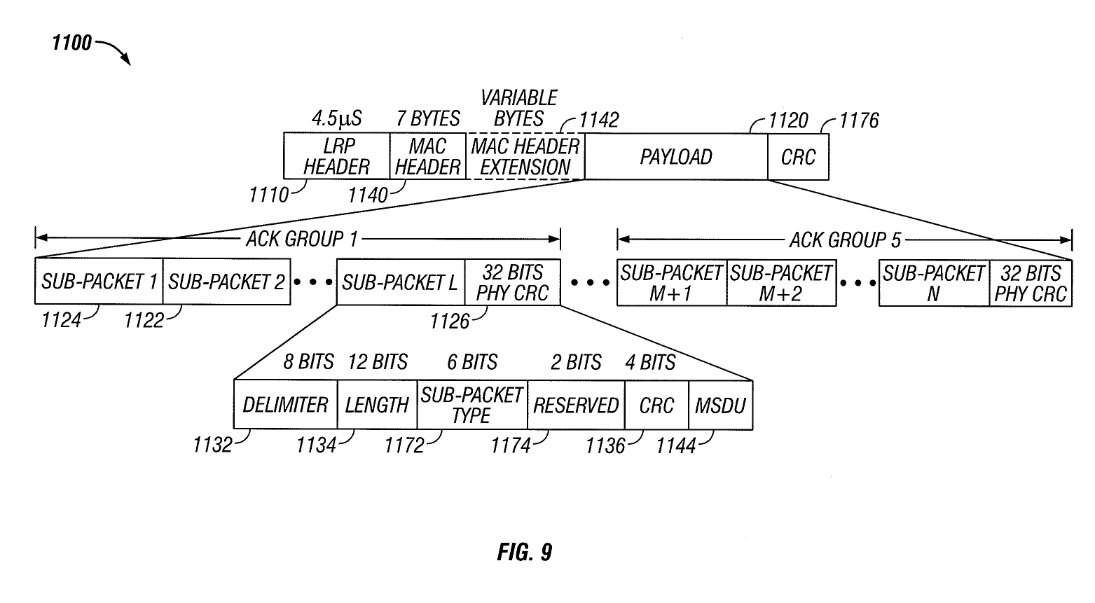

FIG. 9 illustrates an alternative LRP frame format 1100 in which all sub-packets 1124 share one MAC header 1140. The advantage of this approach is that the MAC header overhead is thereby minimized. However, sub-packets with different MAC control configurations cannot be aggregated together. Each sub-packet 1124 comprises an 8-bit delimiter 1132, a 12-bit length information 1134, a 6-bit sub-packet type information 1172, 2 reserved bits 1174, a 4-bit CRC 1136, and a MSDU 1144. The MSDU 1144 is similar to the MAC payload 644 in FIG. 5.

The LRP header 1110, the MAC header 1140, the MAC header extension 1142, the payload 1120, the sub-packet CRC 1126 are the same as illustrated in FIGS. 4-7. In addition, the frame 1176 includes a CRC 1176 appended to the payload 1120.

### LRP Frame Format for Omni-directional Mode

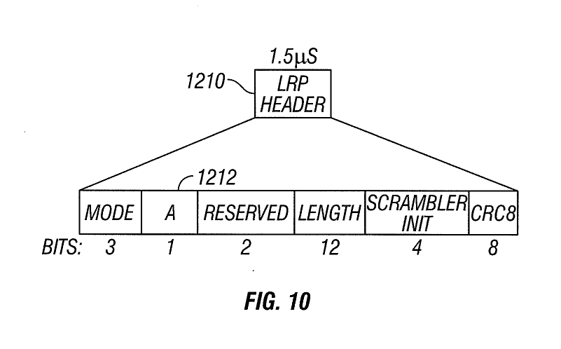

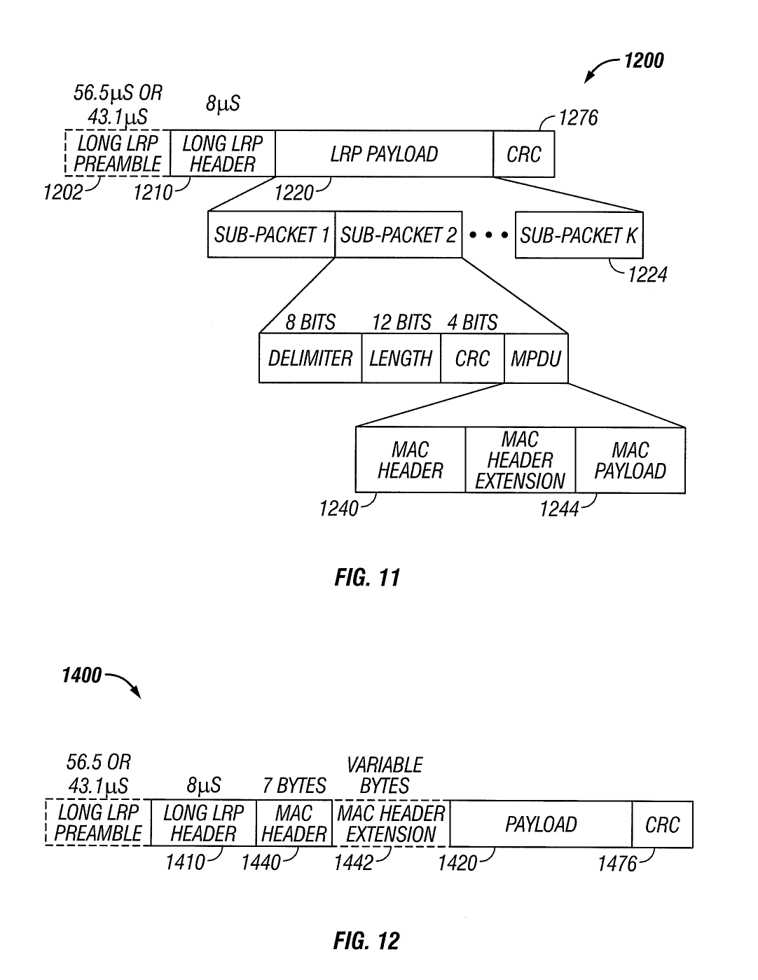

FIG. 11 is a diagram illustrating a LRP frame format 1200 for omni-directional mode, and FIG. 10 is a diagram illustrating a LRP header 1210 for use with the header part shown in FIG. 11.

Referring to FIG. 10, in the LRP header 1210, first of all, one aggregation indication bit 1212 is used to indicate whether it is an aggregated frame or not. The aggregation indication bit is denoted as “A”. If “A” bit is set to “1”, the LRP frame format is as illustrated in FIG. 11. If “A” bit is set to “0”, the LRP frame format is as illustrated below in FIG. 12. There is no ACK group concept for LRP frame format with omni-directional mode since short ACK (with e.g. 5 ACK bits) is not used for acknowledgement of data transmission in omni-directional mode. Thus, the LRP header 1210 does not include length information for each ACK group. The mode, reserved, length, scrambler initial, CRC8 are the same as described with regard to FIG. 4A

Referring to FIG. 11, the LRP payload 1220 may include multiple sub-packets 1224. The format of each sub-packet 1224 is the same as described with regard to FIG. 4. The MAC header is the same as illustrated in FIGS. 5 and 6. As described above with regard to FIG. 5, the security 654, when set to “1”, indicates whether there is security or link adaptation header information stored in the MAC header extension part after the MAC header. For beamformed transmission, since no ReBoM is supported, ReBoM bit 657 can be set to “0”, or this bit can be removed from the MAC control field.

Each sub-packet 1224 in FIG. 11 has its own MAC header. This scheme allows sub-packets with different settings in the MAC control field are aggregated together. For example, different kinds of packets such as beacon, data, and MAC control frames can be aggregated together. Also re-transmitted packets and originally retransmitted packets can also be aggregated. In addition, this scheme improves the transmission reliability. Errors in one MAC header will not affect other sub-packets.

FIG. 12 is a diagram illustrating an exemplary format of the non-aggregated LRP frame format for the omni-directional mode. Unlike the LRP header 1210 in FIG. 11, the “A” bit in the LRP header 1410 in FIG. 12 is set to “0”. This indicates that no aggregation of the sub-packets is to be conducted. There are no sub-packets in the payload 1420. The MAC layer treats the whole payload 1420 as one unit for the non-aggregated LRP frame format 1400. Unlike the LRP frame format in FIG. 11 wherein each sub-packet has its own MAC header and MAC header extension, the frame format in FIG. 12 has a single MAC header 1440, MAC header extension 1442, and CRC 1476 for the whole payload 1420.

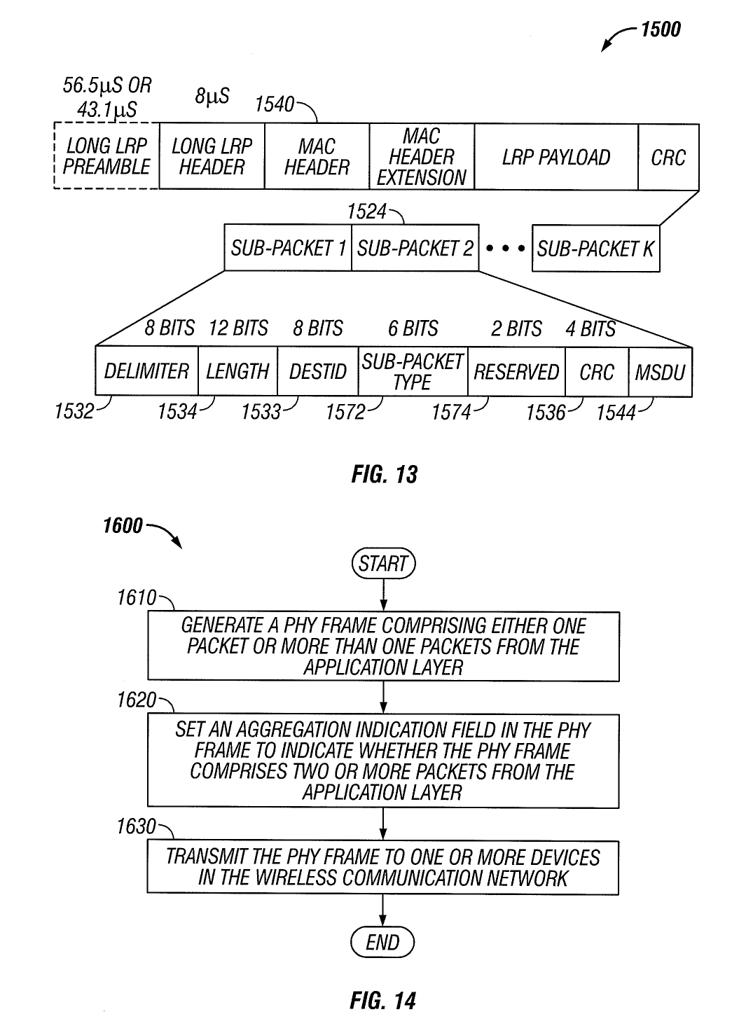

FIG. 13 illustrates an alternative LRP frame format 1500 in which all sub-packets 1524 share one MAC header 1540. The advantage of this approach is that the MAC header overhead is thereby minimized. However, sub-packets with different MAC control configurations cannot be aggregated together. In FIG. 13, each sub-packet 1524 comprises an 8-bit delimiter 1532, a 12-bit length information 1534, an 8 bit destination identification 1533, a 6-bit sub-packet type information 1572, 2 reserved bits 1574, a 4-bit CRC 1536, and a MSDU 1544. The MSDU 1544 is similar to the MAC payload 1244 in FIG. 10.

FIG. 14 is a flowchart illustrating one embodiment of a method of transferring data in a wireless communication network for uncompressed video. The method may be performed, for example, to generate an LRP frame format as described in the forgoing embodiments. The exemplary method 1600 may be performed on, for example, the device 114 or device coordinator 112 as described in FIG. 1 or the transmitter 202 as described in FIG. 2. Depending on the embodiment, the processes to be carried out in the various blocks of the method may be removed, merged together, or rearranged in order. The general principle of the exemplary method will be described as below.

The method 1600 begins at a block 1610, where a PHY frame (e.g., any LRP frame format described above) is generated. The PHY frame may be either not aggregated (i.e., comprising only one packet from the application layer) or aggregated (i.e., comprising two or more packets from the application layer.

Next at a block 1620, an aggregation indication field in the PHY frame is set to indicate whether the PHY frame is aggregated. In one embodiment, the receiver processes the aggregated and non-aggregated frame in differently ways. The aggregation indication field therefore helps the receiver to identify the type of frame received, e.g., aggregated or non-aggregated, and then apply a process most appropriate for the identified type of PHY frame.

Lastly, at a block 1630, the PHY frame is transmitted to one or more devices in the wireless communication network.

In some of the foregoing embodiments, aggregation of sub-packets is used to improve the LRP transmission efficiency, The aggregation of sub-packets may be conveniently applied to many applications. For example, in one embodiment, most MAC control and AV/C messages are exchanged between the coordinator and the associated devices. The packets sent from the coordinator can then be easily aggregated. Further, many control messages are exchanged at the contention period. It is easy to aggregate the packets in this period to allow more packets to be timely transmitted.

Although embodiments of the invention have been described for use in a particular wireless HD video network, the LRP frame structure is not so limited. Embodiments can be used in general with other MAC protocols in wireless network and wireless video network environment.

### CONCLUSION

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

What is claimed is:

1. A method of transmitting data in a wireless network, the method comprising:
generating a physical (PHY) layer frame comprising a PHY layer header and a PHY layer payload data packet, wherein the PAY layer header comprises an aggregation indication bit for indicating whether the PRY layer payload data packet comprises two or more sub-packets received from the application layer; and
transmitting the PHY layer frame.

2. The method of claim 1, wherein the transmitting of the PHY layer frame comprises transmitting the PAY layer frame in a beam-formed mode.

3. The method of claim 1, wherein the PHY payload data packet comprises two or more sub-packets, and wherein the PHY payload data packet further comprises a plurality of acknowledgement (ACK) groups, at least one ACK group further comprising:
a set of sub-packets; and
an ACK group CRC segment for a cyclic redundancy checksum for checking transmission of the set of sub-packets.

4. The method of claim 3, wherein the PHY header further comprises an ACK group length field for at least one ACK group, the ACK group length field indicating the length of the ACK group.

5. The method of claim 3, wherein at least one sub-packet further comprises:
a sub-packet CRC segment for a cyclic redundancy checksum for checking transmission of the sub-packet; and
a media access control (MAC) payload data packet.

6. The method of claim 5, wherein each sub-packet further comprises a media access control (MAC) header for the sub-packet.

7. The method of claim 6, wherein the MAC header comprises a packet type field indicating the MAC type of the sub-packet.

8. The method of claim 6, wherein the MAC header is of a fixed length, and wherein at least one sub-packet further comprises a MAC header extension of a variable length.

9. The method of claim 5, wherein the frame further comprises a MAC header for the frame.

10. The method of claim 9, wherein the MAC header is of a fixed length, and wherein the frame further comprises a MAC header extension of a variable length.

11. The method of claim 9, wherein the PHY header further comprises an ACK group mode field for at least one ACK group, the mode field indicating the PRY mode of the ACK group.

12. The method of claim 1, wherein the wireless network is a high data rate 60 GHz millimeter wave wireless network.

13. The method of claim 1, wherein the PRY layer frame further comprises a PHY preamble, a fixed-length media access control (MAC) header, and a variable-length MAC header extension, and wherein the PHY payload data packet comprises only one packet received from the application layer.

14. The method of claim 1, wherein the transmitting of the PHY layer frame comprises transmitting the PHY layer frame in an omni-directional mode.

15. The method of claim 1, wherein the PHY payload data packet further comprises two or more sub-packets.

16. The method of claim 15, wherein at least one sub-packet further comprises:
a sub-packet CRC segment for a cyclic redundancy checksum for checking transmission of the sub-packet; and
a media access control (MAC) payload data packet.

17. The method of claim 15, wherein at least one sub-packet further comprises a media access control (MAC) header for the sub-packet.

18. The method of claim 17, wherein the MAC header for the sub-packet is of a fixed length, and wherein at least one sub-packet further comprises a MAC header extension of a variable length.

19. The method of claim 17, wherein the MAC header comprises a packet type field indicating the MAC type of the sub-packet.

20. The method of claim 16, wherein the frame further comprises a MAC header for the frame.

21. The method of claim 20, wherein the MAC header for the frame is of a fixed length, and wherein the frame further comprises a MAC header extension of a variable length.

22. A system for transmitting data in a wireless network, the system comprising:
means for generating a physical (PRY) layer frame comprising a PHY header and a PHY payload, the PHY payload comprising one or more packets from the application layer, wherein the PRY header comprises an aggregation indication bit for indicating whether the PHY payload comprises two or more packets from the application layer; and
means for transmitting the PHY frame.

23. A system for transferring data in a wireless network, the system comprising:
a transmitter configured to 1) generate a physical (PHY) layer frame comprising a PHY header and a PHY payload, the PHY payload comprising one or more packets from the application layer, wherein the PHY header comprises an aggregation indication bit for indicating whether the PHY payload comprises two or more packets from the application layer, and 2) transmit the PHY frame; and
a receiver configured to receive a PHY frame from the transmitter, determine whether the frame is aggregated based on the aggregation indication field, and process the PHY frame based on whether the frame is aggregated.
